(19) United States
(12) Patent Application Publication
(10) Pub. No.: US 2009/0049989 A1
(43) Pub. Date: Feb. 26, 2009

(54) WELDING SMOG DISPOSING MACHINE

(76) Inventor: Chieh-Yuan CHENG, Taichung (TW)

Correspondence Address: SINORICA, LLC, 528 FALLSGROVE DRIVE, ROCKVILLE, MD, 20850, US

(21) Appl. No.: 11/842,847

(22) Filed: Aug. 21, 2007

(51) Int. Cl. B01D 46/42; B01D 47/06

(52) U.S. Cl. 96/271; 55/383

(57) ABSTRACT

A welding smog disposing machine includes a depositing frame and a machine box. The machine box is positioned on the depositing frame combined with a contractible frame for receiving a different-sized automatic worktable therein. The machine box has its interior partitioned into a filtration chamber and an exhaust chamber communicating with each other. The exhaust chamber has its bottom bored with an air intake for embers to enter therethrough. After embers produced by the automatic worktable is pumped to the interior of the machine box, the exhaust chamber filtrates oily smog, filthy air and impurities and then the filtration chamber carries out filtration for a second time. Thus, the embers can be cleaned out and filtrated, and the air exhausted out is completely unpolluted, effectively maintaining good quality of air in a work environment.

### BACKGROUND OF THE INVENTION

1. Field of the Invention

This invention relates to a welding smog disposing machine, particularly to one able to effectively dispose of smog and embers produced during carrying out electric welding work.

2. Description of the Prior Art

Generally, when a metal welding factory carries out argon welding, electric welding or heat treatment, a great quantity of welding smog containing volatile matter of heavy metal like lead, manganese and nickel will be produced. Therefore, when automatic worktables in such metal welding factories are operated, a great quantity of filthy air, impurities and embers will be produced to pollute the surroundings around and harm air quantity of the surroundings and, what's worse, many of such factories blocked by nearby buildings are badly ventilated. To solve the problem of environment pollution caused by electric welding, some metal welding factories are installed with industrial air filtration equipment for carrying out filtration of air. Such industrial air filtration equipment is generally provided with one or more filter nets for carrying out filtration. However, during the electric welding work, lots of oily dirty and impurities will be produced and therefore, the filter nets are likely to be clogged with such oily dirt and impurities and necessary to be frequently washed clean or replaced with new ones to avoid deteriorating the air around. In another case, if air filtration equipment is installed at a high location, it is necessary to take too much time and lab or in disassembling and washing the air filtration equipment.

### SUMMARY OF THE INVENTION

The objective of this invention is to offer a welding smog disposing machine including a depositing frame and a machine box. The machine box is assembled on the depositing frame having one side combined with a contractible frame. The machine box has its interior partitioned into a filtration chamber and an exhaust chamber communicating with each other. The exhaust chamber has its bottom bored with an air intake for embers to pass therethrough, and the filtration chamber is disposed inside with a funnel shade having its upper and lower opening communicating with each other. The funnel shade has its outside provided with a movable filter cloth device, and the exhaust chamber is installed with a filter cylinder set and a blower in the interior. The filter cylinder set is composed of a plurality of cylinders arranged spaced apart equidistantly, and plural pressure air pipes and a water sprinkling pipe are assembled over the filter cylinder set. The blower is installed in a casing and positioned adjacent to the filter cylinder set, and the casing has one side assembled with an exhaust box communicating with the casing and having its topside provided thereon with an exhaust net.

The welding smog disposing machine in the present invention is provided with the contractible frame combined with one side of the depositing frame for receiving different-sized automatic worktables therein. Embers produced by the automatic worktable will be pumped to enter the exhaust chamber and the filtration chamber of the machine box through the air intake to have oily smog, filthy air and impurities filtrated by both the filter cylinder set and the movable filter cloth device. After being filtrated, unpolluted air will be pumped to the exhaust box by the blower and exhausted out through the exhaust net of the exhaust box. In addition, the exhaust chamber is provided inside with the pressure air pipes and the water sprinkling pipe for cleaning out embers produced in the machine box and preventing the filter cylinder set from being clogged by oily dirt and impurities, thus needless to wash or replace the filter cylinder set frequently and able to maintain good quality of air in a work environment.

### BRIEF DESCRIPTION OF DRAWINGS

This invention will be better understood by referring to the accompanying drawings, wherein:

FIG. 1 is a perspective view of a welding smog disposing machine in the present invention;

FIG. 2 is an exploded perspective view of the welding smog disposing machine in the present invention;

FIG. 3 is a side cross-sectional view of a filtration chamber of the welding smog disposing machine in the present invention;

FIG. 4 is a perspective and cross-sectional view of the welding smog disposing machine in the present invention;

FIG. 5 is another perspective and cross-sectional view of the welding smog disposing machine in the present invention; and

FIG. 6 is an upper view of the welding smog disposing machine in the present invention.

### DETAILED DESCRIPTION OF THE PREFERRED EMBODIMENT

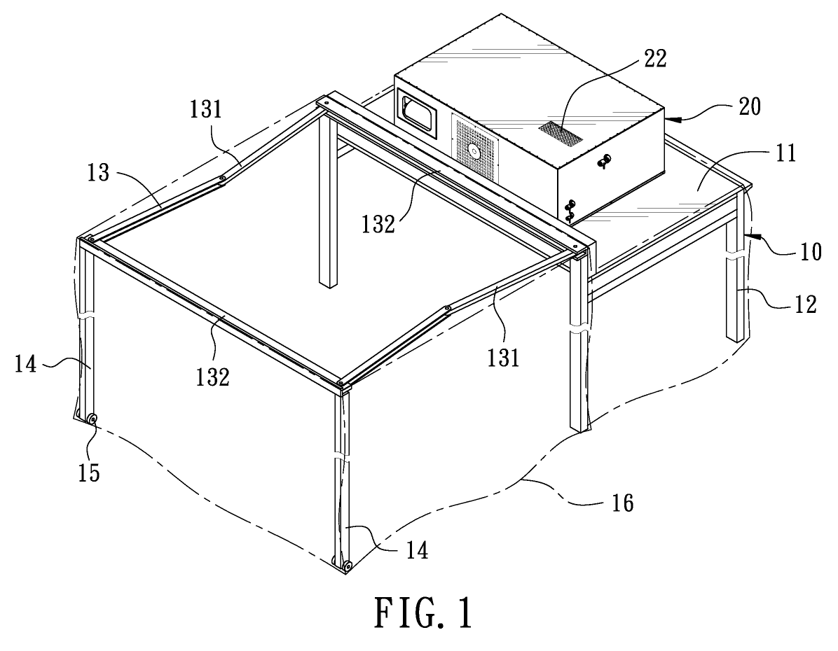

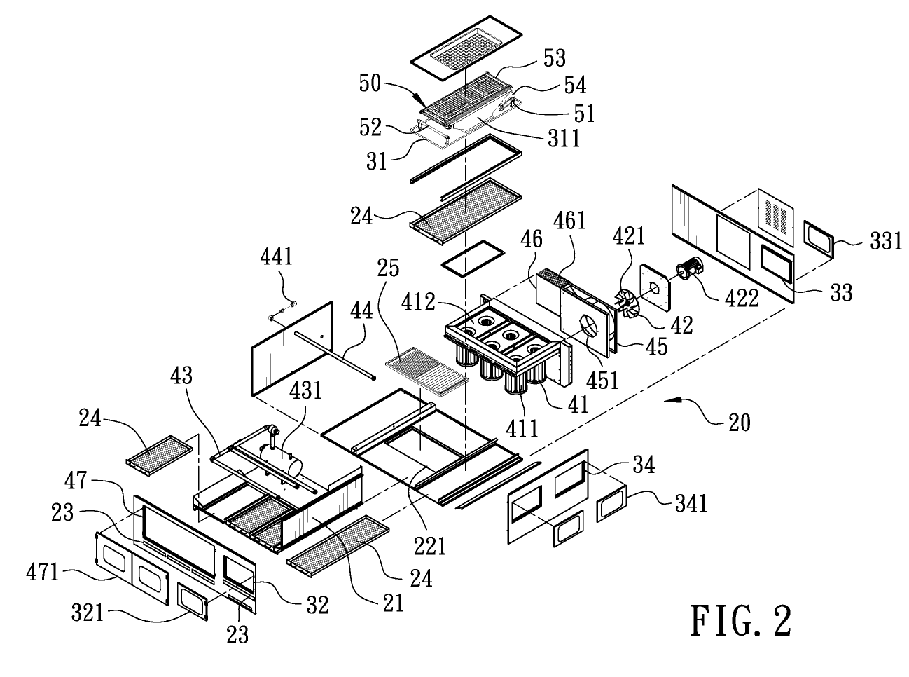

A preferred embodiment of a welding smog disposing machine in the present invention, as shown in FIGS. 1 and 2, includes a depositing frame 10, a machine box 20, a filtration chamber 30 and an exhaust chamber 40 as main components combined together.

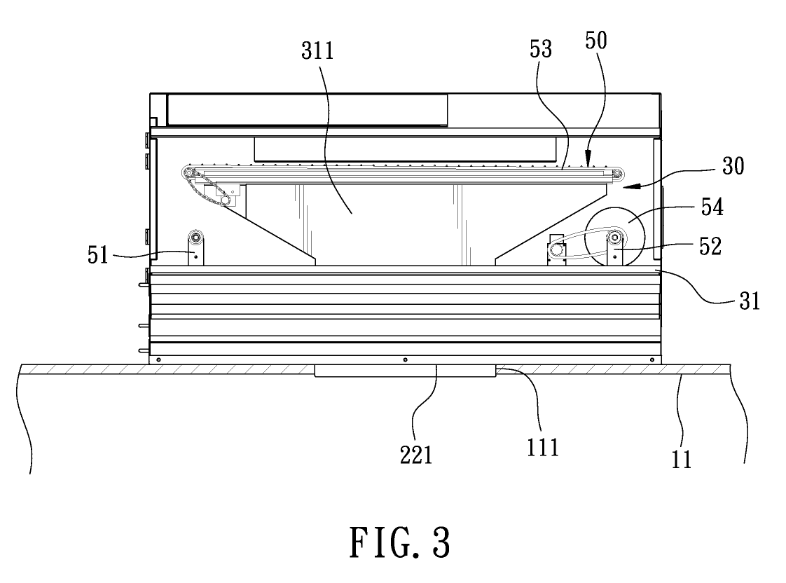

The depositing frame 10 is a table formed with a support surface 11 and having four feet 12 of proper height secured with the underside of the support surface 11 for standing on the ground. The support surface 11 of the depositing frame 10 is to be fixed at a location away from a ceiling for a proper distance. The support surface 11 has its bottom bored with a through hole 111, as shown in FIG. 3, and a working space is formed among the four foot posts for placing an automatic worktable to let the automatic worktable work under the depositing frame 10. The depositing frame 10 has one side combined with a contractible frame 13, which is a rectangular frame formed by connecting two parallel transverse rods 131 with two parallel straight rods 132 together. The two transverse rods 131 respectively consist of two parts pivotally connected together for facilitating to be collapsed, and the straight rod 132 at one side opposite to the depositing frame 10 has the underside of its opposite ends respectively fixed with a foot 14 having a caster 15 pivotally assembled on the lower end for the contractible frame 13 to be conveniently collapsed or stretched to stand on the ground. Thus, when a large-size automatic worktable is employed, the contractible frame 13 can be stretched for covering the large-size automatic worktable. Further, the depositing frame 10 and the contractible frame 13 have their periphery provided with a transparent curtain 16 hanging downward to cover up the automatic worktable positioned in a space among the feet 12 and 14 for preventing external dust from entering the automatic worktable.

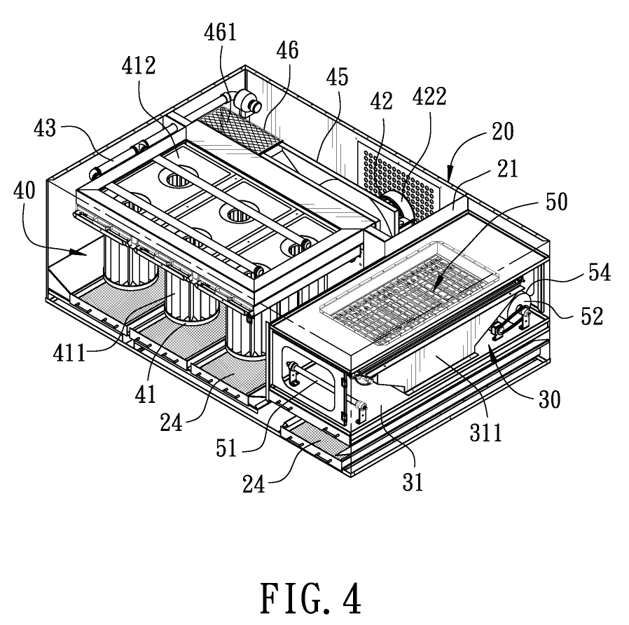

Referring to FIG. 4, the machine box 20 is mounted on the support surface 11 of the depositing frame 10, provided with a separating plate 21 with a proper height to partition its lower interior portion into a filtration chamber 30 and an exhaust chamber 30 abutting and communicating with each other. The machine box 20 is bored with a notch 22 at a proper location of its topside, and has a lower front side beneath the filtration chamber 30 bored with two insert slots 23 orderly arranged from above to below and another lower front side beneath the exhaust chamber 40 bored with three insert slots 23 orderly arranged from left to right, with a drawer-type filter sheet set 24 received in these insert slots 23 and positioned on the bottom of the machine box 20. The filtration chamber 30 and the exhaust chamber 40 are located over the filter sheet set 24, communicating with each other. The exhaust chamber 40 has its bottom bored with an air intake 221 matching with the through hole 111 of the depositing frame 10 for embers to enter therethrough, having a blade set 25 assembled on the air intake 221.

The filtration chamber 30 is assembled with a foundation plate 31 at a location corresponding to the filter sheet set 24 below. The foundation plate 31 is fixed thereon with a funnel shade 311 gradually narrowed toward the foundation plate 31 and having its upper and lower opening communicating with each other. A movable filter cloth device 50 is installed at the outside of the funnel shade 311, composed of a first winding base 51, a second winding base 52, a rotary wheel set 53 and a filter cloth roll 54. The first winding base 51 and the second winding base 52 are respectively positioned at the front side and the rear side of the funnel shade 311, and the rotary wheel set 53 is assembled on the upper opening of the funnel shade 311, with the lower opening of the funnel shade 311 penetrating through the foundation plate 31 and facing the filter sheet set 24. The filter cloth roll 54 has one end wound on the first winding base 51 and another free end pulled upward to pass on the rotary wheel set 53 and cover on the upper opening of the funnel shade 311 and then moved downward to be wound on the second winding base 52. In addition, the machine box 10 has one side, corresponding to the second winding base 52, bored with an opening 32 having a door panel 321 pivotally assembled thereon, and another side corresponding to the first winding base 51 bored with another opening 33 having a door panel 331 pivotally assembled thereon. The machine box 10 further has a lateral side between the opening 32 and the opening 33 provided with two openings 34 respectively having a door panel 341 pivotally fixed thereon.

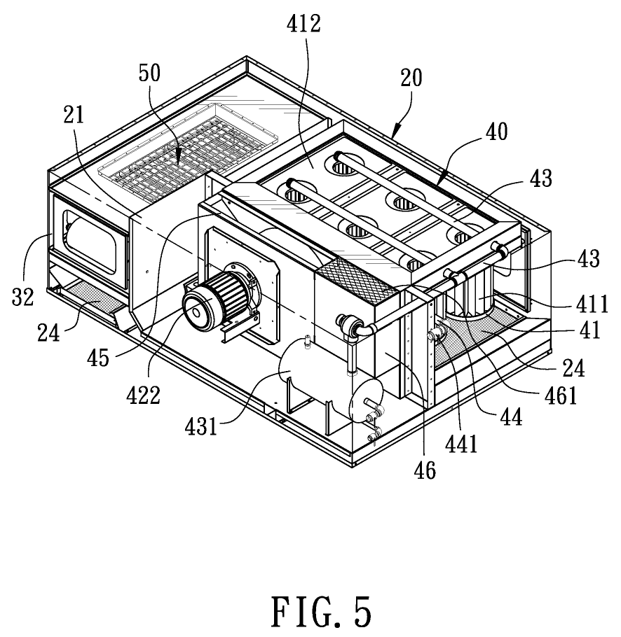

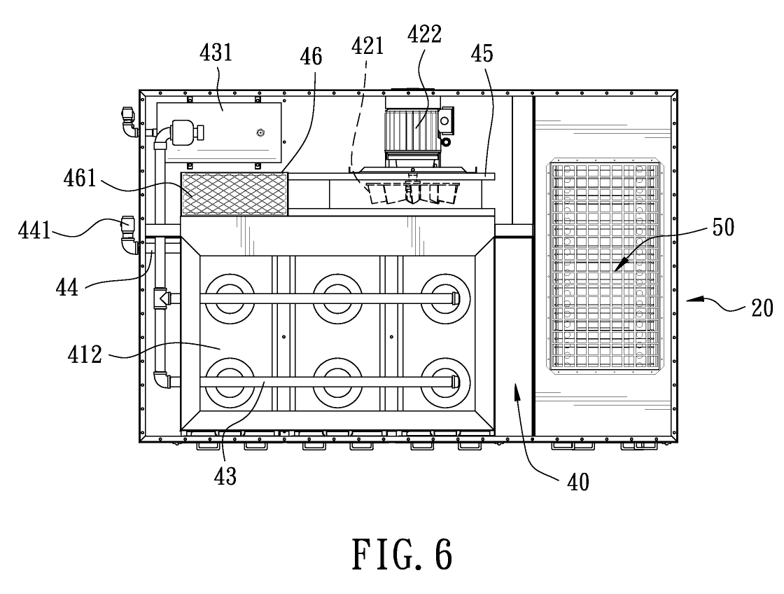

Referring to FIG. 5 and 6, the exhaust chamber 40 is provided with a filter cylinder set 41 and a blower 42 in the interior. The filter cylinder set 41 is composed of a plurality of filter cylinders 411 arranged spaced apart equidistantly, having its topside secured with a plate 412 to be hung inside the exhaust chamber 40. The filter cylinder set 41 is positioned above the air intake 221 of the exhaust chamber 40 to face the filter sheet set 24 under the air intake 221. The filter cylinder set 41 has its topside transversely and equidistantly combined with two pressure air pipes 43 provided with a plurality of nozzles (not shown) facing the filter cylinder set 41. Further, the exhaust chamber 40 has one sidewall provided with a water sprinkling pipe 44, and the machine box 20 has its outside fixed with a water sprinkling switch 441 connected with the water sprinkling pipe 44. The blower 42 is installed at a location adjacent to a rear end of the filter cylinder set 41, composed of a fan 421 and a driving motor 422. The fan 421 facing the filter cylinder set 41 is received in a casing 45, which is bored with a round opening 451 facing the filter cylinder set 41 and has an exhaust box 46 assembled at one side and communicating with the casing 45. The exhaust box 46 has its topside covered with an exhaust net 461 exactly aligned to the notch 22 of the machine box 20. A pressure air tank 431 connected with one end of the pressure air pipes 43 is disposed beside the exhaust box 46. Furthermore, the exhaust chamber 40 has one side opposite to the insert slots 23 is bored with an opening 47 having its opposite sides respectively and pivotally assembled thereon with a door panel 471.

When the automatic worktable is to carry out electric welding work, start the welding smog disposing machine on the depositing frame to let the blower 42 pump embers produced during electric welding into the exhaust chamber 40 through the air intake 221 to be filtrated by the filter cylinder set 41. Next, the pressure air pipes 43 will for a set time jet vacuum gas to the filter cylinder set 41 for timely washing away the embers adhered to the filter cylinder set 41 to let the embers drop down to the filter sheet set 24, and then timely open the water sprinkling pipe 44 to put out the embers and prevent them from entering the machine box 20 to cause a fire. At this time, parts of filthy air will be pumped to get on the filter cloth of the movable filter cloth device 50 to be filtrated and then moved by the movable filter cloth to drop down to the filter sheet set 24 through the openings of the funnel shade 31. Afterward, unpolluted air after filtrated will be pumped by the blower 42 to get into the exhaust box 46 that communicates with the casing 45 and exhausted out of the machine box 20 through the exhaust net 46. Thus, the air exhausted out is completely unpolluted and clean, able to effectively maintain good quality of air in the work environment.

After the filter cloth roll 54 of the movable filter cloth device 50 has been used for a period of time and the filtration surfaces of the whole filter cloth roll 54 have been used up, the filter cloth roll 54 has to be replaced with a new one. To replace the filter cloth roll 54, simply open the door panels 321 and 331, remove the used filter cloth roll 54 from the second winding base 52, and then a new filter cloth roll 54 is assembled on the first winding base 51, having its free end pulled upward to pass on the rotary wheel set 53 and then moved downward to be wound on the second winding base 52. In addition, the filter sheet set 24 positioned at the bottom of the machine box 20 can conveniently be drawn out to be washed clean or replaced with a new one.

As can be understood from the above description, this invention has the following advantages.

1. The depositing frame enables the machine box to be placed at a proper height for pumping and disposing of oily smog and embers produced by the automatic worktable positioned inside the depositing frame, and the contractible frame convenient to be collapsed or stretched for use is combined with one side of the depositing frame for receiving different-sized automatic worktable therein. In addition, both the depositing frame and the contractible frame have their peripheral provided with a transparent curtain hanging downward so as to prevent external dust from getting in the automatic worktable.

2. The machine box has its interior partitioned into the filtration chamber and the exhaust chamber. After embers are pumped to the interior of the machine box, oily smog, foul air and impurities can be first filtrated by the exhaust chamber and then filtrated for a second time by the filtration chamber; therefore, air exhausted out is completely unpolluted, effectively cleaning away and filtrating the embers produced by the automatic worktable, and maintaining good quality of air in a work environment.

3. The pressure air pipes installed inside the exhaust chamber can function to remove away the dust and embers adhered to the filter cylinder set, able to prolong service life and elevate filtration quality of the filter cylinder set, and the water sprinkling pipe provided in the exhaust chamber is used for extinguishing the embers to prevent them from entering the machine box and causing a fire, enabling the machine box to carry out filtration conveniently and safety.

While the preferred embodiment of the invention has been described above, it will be recognized and understood that various modifications may be made therein and the appended claims are intended to cover all such modifications that may fall within the spirit and scope of the invention.

I claim:

1. A welding smog disposing machine comprising:
a depositing frame shaped as a table formed with a support surface, said support surface having its four corners respectively secured with a foot with a proper height to stand on the ground, said support surface positioned at a location away from a ceiling for a proper distance, said support surface bored with a through hole at a proper location, a working space formed among said feet for placing an automatic worktable therein, said depositing frame having one side combined with a contractible frame;
a machine box positioned on said support surface of said depositing frame, said machine box having its lower interior portion partitioned into a filtration chamber and an exhaust chamber by a separating plate with a proper height, said filtration chamber communicating with said exhaust chamber, said exhaust chamber having its bottom bored with an air intake at a location corresponding to said through hole of said support surface for embers to enter therethrough, said air intake assembled thereon with a blade set;
said filtration chamber provided inside with a funnel shade having its upper and lower opening communicating with each other and gradually narrowed toward its lower side, said funnel shade having its outside assembled with a movable filter cloth device; and
said exhaust chamber installed with a filter cylinder set and a blower in an interior, said filter cylinder set installed at a location over said air intake and composed of a plurality of filter cylinders arranged spaced apart equidistantly, said blower positioned abutting one side of said filter cylinder set, composed of a fan and a driving motor, said fan facing said filter cylinder set and received in a casing, said casing bored with an opening at one side facing said filter cylinder set, said casing abutting on an exhaust box and communicating with said exhaust box, said exhaust box assembled thereon with an exhaust net.

2. The welding smog disposing machine as claimed in claim 1, wherein said contractible frame is a rectangular frame formed by combining two parallel transverse rods with two parallel straight rods, said two parallel transverse rods respectively consisting of two parts pivotally connected together for facilitating to be collapsed, said straight rod at outside having its opposite ends respectively fixed with a foot, said foot pivotally assembled with a caster for facilitating said contractible frame to be collapsed or stretched to stand on the ground.

3. The welding smog disposing machine as claimed in claim 1, wherein both said depositing frame and said contractible frame have their periphery disposed with a transparent curtain hanging downward.

4. The welding smog disposing machine as claimed in claim 1, wherein said movable filter cloth device is composed of a first winding base, a second winding base, a rotary wheel set and a filter cloth roll, said first winding base and said second winding base respectively positioned at two opposite sides of said funnel shade, said rotary wheel set positioned on an upper opening of said funnel shade, said filter cloth roll having one end wound on said first winding base and another end pulled upward to pass on said rotary wheel set and then moved downward to be wound on said second winding base.

5. The welding smog disposing machine as claimed in claim 1, wherein one pressure air pipe is transversely provided over said filter cylinder set in said exhaust chamber and a water sprinkling pipe is disposed at one sidewall of said exhaust chamber.

6. The welding smog disposing machine as claimed in claim 5, wherein a pressure air tank connected with one end of said pressure air pipe is provided at a location be side said exhaust box in said exhaust chamber.

7. The welding smog disposing machine as claimed in claim 5, wherein a water sprinkling switch connected with said water sprinkling pipe is installed at an outside of said machine box.

8. The welding smog disposing machine as claimed in claim 1, wherein said machine box has an outside bored with a notch at a location matching with said exhaust net on said exhaust box.

9. The welding smog disposing machine as claimed in claim 1, wherein said machine box has one lower side bored with at least one insert slot for a drawer-type filter sheet set to be inserted therein, said filtration chamber and said exhaust chamber communicating with said filter sheet set.

10. The welding smog disposing machine as claimed in claim 1, wherein said filtration chamber and said exhaust chamber respectively have one side bored with at least one opening having a door plank pivotally assembled thereon.
